(19) United States
(12) Patent Application Publication
(10) Pub. No.: US 2026/0344940 A1
(43) Pub. Date: Nov. 5, 2026

(54) UTENSIL WITH MANUAL ACTUATOR CONTROLLED ROTATION

(71) Applicant: Nolan Kosciukiewicz, Newington (CT)

(72) Inventor: Nolan Kosciukiewicz, Newington (CT)

(21) Appl. No.: 19/661,490

(22) Filed: Apr. 28, 2026

Related U.S. Application Data
(60) Provisional application No. 63/797,574, filed on Apr. 30, 2025.

(51) Int. Cl. A47J 43/28

(52) U.S. Cl. CPC A47J 43/288; A47J 43/283

(57) ABSTRACT

A rotating utensil system includes a utensil, particularly a kitchen utensil, that has manual controlled rotation via a manual rotation assembly configured between the utensil shaft and the handle. The manual rotation assembly includes an actuator that incorporates a plunger that can be manually actuated to rotate the utensil shaft and the utensil, such as a spatula to rotate at least 160 degrees. The plunger may move linearly, including along a curve, down into the actuator enclosure and has a plunger gear that interfaces with a shaft gear, coupled to the utensil shaft. When the plunger is pushed down, the shaft gear rotates and this rotates the utensil to enable flipping of food products completely upside down. A spring element in the actuator enclosure creates a force on the plunger to force the plunger back out of the actuator enclosure to a ready position.

### CROSS REFERENCE TO RELATED APPLICATIONS

This application claims the benefit of priority to U.S. provisional patent application No. 63/797,574, filed on Apr. 30, 2025; the entirety of which is hereby incorporated by reference herein.

### BACKGROUND OF THE INVENTION

### Field of the Invention

The invention relates a utensil with a manual controlled rotation, and in particular, a spatula implement that is configured to rotate more than 160 degrees via a lever.

### Background

When cooking, it is often required to flip a food item, to evenly cook both sides, such as when cooking pancakes, or hamburgers as examples. A spatula is often used for this purpose. Some people have trouble flipping food items over, as they do not have the dexterity in their hand, wrist and/or arm to flip the food item effectively. Other types of utensils can also be used for flipping food items, including forks, spoons and the like. Rotating these utensils can also pose challenges for some people.

### SUMMARY OF THE INVENTION

The invention relates a utensil with a manual controlled rotation, such as a spatula, that is configured to rotate more than 160 degrees via a manual rotation assembly A rotating utensil system, includes a utensil, particularly a kitchen utensil, that has manual controlled rotation via a manual rotation assembly configured between the utensil shaft and the handle. The manual rotation assembly includes an actuator that incorporates a plunger that can be manually actuated to rotate the utensil shaft and the utensil, such as a spatula to rotate at least 160 degrees and preferably about 180 degrees. The plunger may move linearly, including along a curve, down into the actuator enclosure and has a plunger gear that interfaces with a shaft gear, coupled to the utensil shaft. When the plunger is pushed down, the shaft gear rotates and this rotates the utensil to enable flipping of food products completely upside down. A spring element in the actuator enclosure creates a force on the plunger to force the plunger back out of the actuator enclosure to a ready position.

With the plunger in a ready position, the plunger is extended up from the actuator enclosure through the plunger gear aperture in the actuator enclosure. The plunger can be depressed or actuated down into the actuator enclosure to rotate the utensil.

The handle extends a length from an actuator end to a hand end, an extended end from the actuator enclosure, and may have finger detents along a base side of the handle to receive fingers therein when holding by hand and operating the manual rotation assembly to manipulate and rotate the utensil. The handle may be detachable from the actuator enclosure by a handle coupler.

The plunger has a plunger interface on the plunger thumb end and this plunger interface may have a plunger interface extension that extends back toward the handle or handle end of the rotating utensil to enable easier reach of a person's thumb onto the plunger interface. The plunger interface may extend a length of about 2 cm or more, about 3 cm or more, about 5 cm or more, or even about 7 or 8 cm or more to enable easy reach and manipulation. The rotating utensil extends a length from the handle end to the utensil end that may be about 35 cm or more, about 25 cm or more, about 20 cm or more, about 15 cm or more and any range between and including the values provided.

The manual rotation assembly includes a plunger having a plunger gear with a series of plunger gear teeth that interface or mate with the shaft gear teeth of the shaft gear, forming a worm gear assembly, wherein linear movement of the plunger causes rotation of the shaft gear. The shaft gear is a circular gear or gear wheel having shaft gear teeth that extend axially around the outer perimeter of the gear wheel.

The utensil shaft is coupled to and extends from the shaft gear and may be detachably attachable to the shaft gear via a utensil coupler, configured proximal to the shaft-handle end. The utensil coupler may include a protrusion, such as a ball, and a protrusion aperture coupling arrangement with a protrusion extending through said protrusion aperture to secure the two components together, as shown. The protrusion may be pressed down through the aperture to enable the shaft to decouple from the shaft gear.

The manual rotation assembly may include a first enclosure component and a second enclosure component, that may be secured together to form the actuator enclosure. The actuator enclosure has a plunger gear aperture for the plunger and plunger gear to move therethrough and a shaft gear aperture that enables the utensil shaft and/or a portion of the shaft gear to extend therethrough.

The summary of the invention is provided as a general introduction to some of the embodiments of the invention and is not intended to be limiting. Additional example embodiments including variations and alternative configurations of the invention are provided herein.

### BRIEF DESCRIPTION OF SEVERAL VIEWS OF THE DRAWINGS

The accompanying drawings are included to provide a further understanding of the invention and are incorporated in and constitute a part of this specification, illustrate embodiments of the invention, and together with the description serve to explain the principles of the invention.

FIG. 1 shows a side perspective view of the rotating utensil system that forms a utensil with a manual controlled rotation via a manual rotation assembly configured between the shaft of the utensil and the handle and having an actuator, a plunger, that can be manually actuated to rotate the utensil shaft and the utensil, such as a spatula to rotate or flip a first surface at least 160 degrees.

FIG. 2 shows a side perspective view of the rotating utensil shown in FIG. 1 with the plunger depressed and the handle and utensil rotated.

FIG. 3 shows a perspective view of a portion of the rotating utensil, the manual rotation assembly having a plunger gear that extends out of the actuator enclosure and interfaces with the shaft gear, forming a worm gear assembly, wherein the plunger moves linearly, and the shaft gear rotates due to the gear interface.

FIG. 4 shows a perspective view of the components of the manual rotation assembly including the shaft gear, that may be detachably attachable to the utensil shaft, the plunger and plunger gear, the first enclosure component having a spring element therein to return the plunger gear to a ready position and the second enclosure component.

Corresponding reference characters indicate corresponding parts throughout the several views of the figures. The figures represent an illustration of some of the embodiments of the present invention and are not to be construed as limiting the scope of the invention in any manner. Some of the figures may not show all of the features and components of the invention for ease of illustration, but it is to be understood that where possible, features and components from one figure may be included in the other figures. Further, the figures are not necessarily to scale, some features may be exaggerated to show details of particular components. Therefore, specific structural and functional details disclosed herein are not to be interpreted as limiting, but merely as a representative basis for teaching one skilled in the art to employ the present invention.

### DETAILED DESCRIPTION OF THE ILLUSTRATED EMBODIMENTS

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

Certain exemplary embodiments of the present invention are described herein and are illustrated in the accompanying figures. The embodiments described are only for purposes of illustrating the present invention and should not be interpreted as limiting the scope of the invention. Other embodiments of the invention, and certain modifications, combinations and improvements of the described embodiments, will occur to those skilled in the art and all such alternate embodiments, combinations, modifications, improvements are within the scope of the present invention.

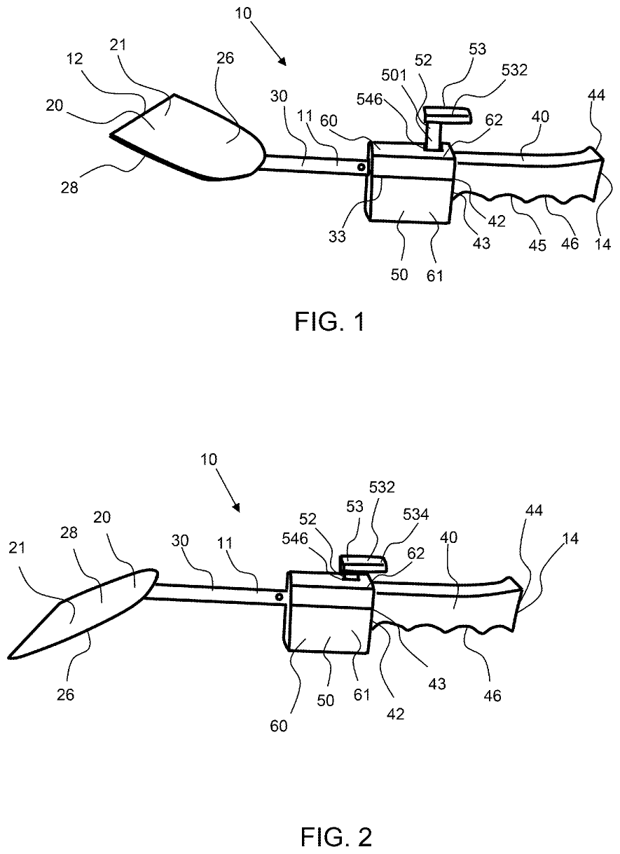

Referring now to FIGS. 1 and 2, a rotating utensil system 10, is a utensil, particularly a kitchen utensil, that has manual controlled rotation via a manual rotation assembly 50 configured between the utensil shaft 30 of the utensil 20 and the handle 40, and has an actuator 501, that includes a plunger 52, that can be manually actuated to rotate the utensil shaft and the utensil, such as a spatula 21 to rotate or flip a first surface 26 at least 160 degrees and preferably about 180 degrees, such that the second surface 28 of the utensil 20 is now the up side and the first surface 26 is the down side, as shown in FIG. 2. The rotating utensil apparatus 11 may have a plurality of utensils 20 that are interchangeable, being able to detachably attach to the manual rotation assembly 50.

The plunger 52 moves linearly, including along a curve, down into the actuator enclosure 60 and has a plunger gear that interfaces with a shaft gear, coupled to the utensil shaft 30. When the plunger is pushed down, the shaft gear rotates and this rotates the utensil 20, the spatula 21, to enable flipping of food products completely upside down.

As shown in FIG. 1, the plunger 52 is in a ready position, extended out from the actuator enclosure 60 through the plunger gear aperture 546 in the actuator enclosure 60. As shown in FIG. 2, the plunger is depressed or actuated down into the actuator enclosure and this has rotated the utensil 20, the spatula 21, such that the first surface 26 of the spatula is now facing more than 160 degrees from the position shown in FIG. 1. The second surface 28 is now facing up with the first surface 26 facing down.

The handle 40 extends a length from an actuator end 42 to a hand end 44, an extended end from the actuator enclosure 60, and may have finger detents 46 along a base side 45 of the handle to receive fingers therein when holding by hand and operating the manual rotation assembly 50 to manipulate and rotate the utensil. The handle may be detachable from the actuator enclosure 60 by a handle coupler 43, such as a snap fit coupling arrangement, which may have tabs that deflect to secure the handle in the receiver.

The plunger 52 has a plunger interface 532 on the plunger thumb end 53 and this plunger interface may have a plunger interface extension 534 that extends back toward the handle 40 or handle end 14 of the rotating utensil apparatus 11 to enable easier reach of a person's thumb onto the plunger interface. The rotating utensil apparatus 11 extends a length from the handle end 14 to the utensil end 12 that may be about 35 cm or more, about 25 cm or more, about 20 cm or more, about 15 cm or more and any range between and including the values provided.

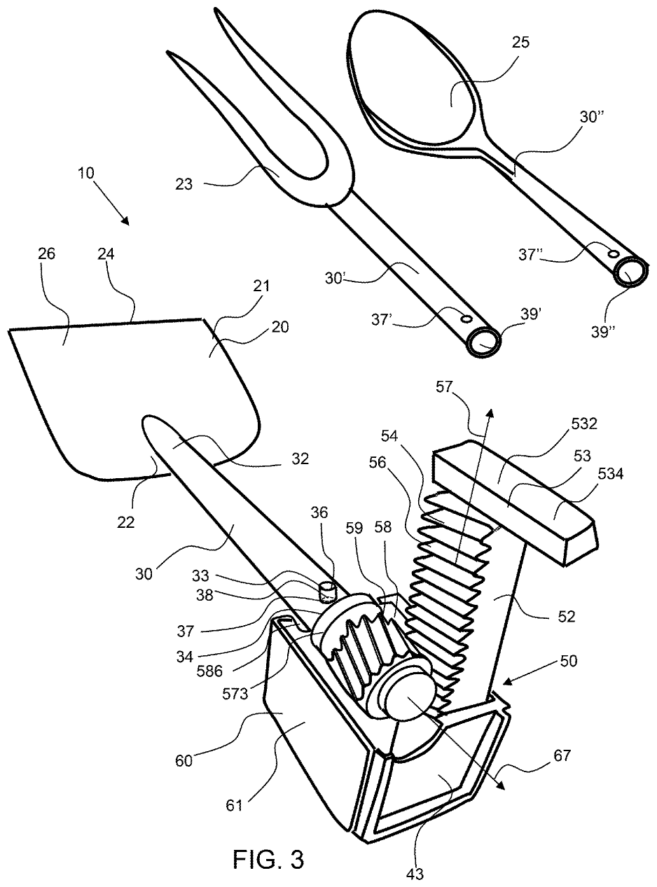

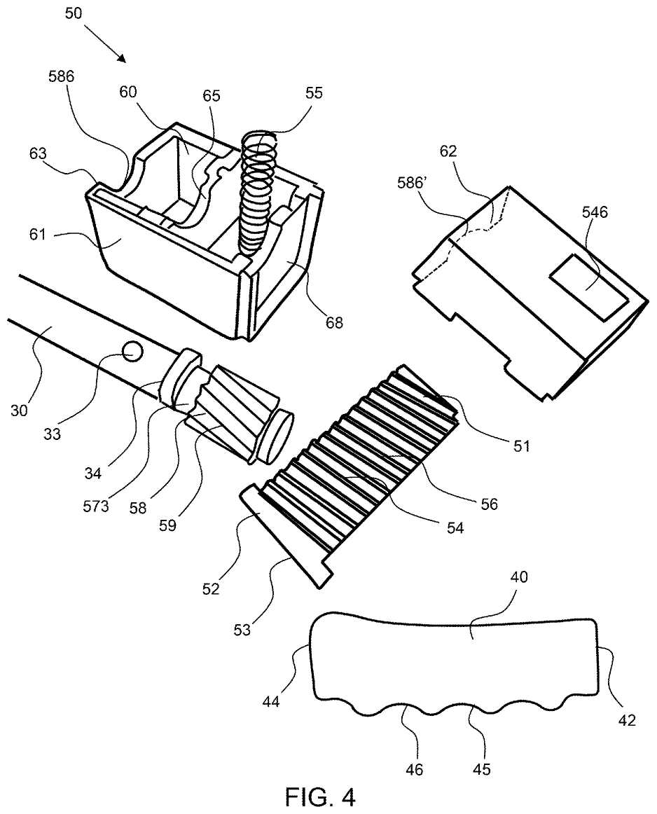

Referring now to FIGS. 3 and 4, the manual rotation assembly 50 includes a plunger 52 having a plunger gear 54 that extends from the plunger insert end 51, to the plunger thumb end 53. The plunger has a series of plunger gear teeth 56 that interface or mate with the shaft gear teeth 59 of the shaft gear 58, forming a worm gear assembly, wherein linear movement of the plunger causes rotation of the shaft gear. The axis of rotation 67 of the shaft gear 58 is generally orthogonal to the axis of movement 57 of the plunger gear 54, or within about 10 degrees of orthogonal.

As shown in FIG. 3, the spatula 21 and the other utensils extend from an attached end 22, attached to the utensil shaft 30, to an extended end 24. The utensil shaft 30 has a shaft-utensil end 32, coupled to the utensil and a shaft-handle end 34, coupled to the shaft gear 58.

The utensil shaft 30 is coupled to and extends from the shaft gear 58 and may be detachably attachable to the shaft gear via a utensil coupler 33, configured proximal to the shaft-handle end 34. The utensil coupler may include a protrusion 36, such as a ball, and a protrusion aperture 37 coupling arrangement with a protrusion extending through said protrusion aperture to secure the two components together, as shown. A protrusion-spring 38 may force the protrusion or ball up through the protrusion aperture requiring a force to push the protrusion back through the protrusion aperture to detach the utensil handle from the shaft gear or portion thereof, such as an extension from the shaft gear that extends axially along the axis of rotation 67 of the shaft gear. The protrusion may be pressed down through the aperture to enable the utensil shaft 30 to decouple from the shaft gear 58. As shown in FIG. 3, a rotating utensil system may include a plurality of utensils that are detachably attachable to the manual rotation assembly 50. A fork 23 and spoon 25 are shown detached and the spatula attached. Each utensil may have a coupling aperture 39, 39′ for extending over a shaft gear extension 573, an axial extension from the shaft gear 58 (best shown in FIG. 4) that may have the protrusion 36 of the utensil coupler 33. The protrusion may have a protrusion-spring 38 to force the protrusion up through the protrusion aperture 37.

The manual rotation assembly 50 includes a first enclosure component 61 and a second enclosure component 62, that may be secured together to form the actuator enclosure 60. The actuator enclosure has a plunger gear aperture 546 for the plunger and plunger gear to move therethrough and a shaft gear aperture 586 that enables the utensil shaft 30 and/or a portion of the shaft gear 58 to extend therethrough. The shaft gear aperture may be configured between the first enclosure component 61 and the second enclosure component 62, wherein each component forms a portion of the shaft gear aperture 586, 586′, respectively. The actuator enclosure has a gear box shaft end 63 and a gear box handle end 68. The shaft gear 58 may be retained in the actuator enclosure 60 by a shaft gear retainer 65, a flange that extends into a recess, such as a radial recess or groove in an extension from the shaft gear or shaft gear teeth.

As shown in FIG. 4, the plunger 52 and plunger gear 54 are forced by a spring element 55 up out of the actuator enclosure 60 to a ready position, as shown in FIG. 1. The spring element 55 may be a coiled spring as shown or may be an elastomeric component, such as a living hinge, a bent piece of spring steel for example.

It will be apparent to those skilled in the art that various modifications, combinations and variations can be made in the present invention without departing from the scope of the invention. Specific embodiments, features and elements described herein may be modified, and/or combined in any suitable manner. Thus, it is intended that the present invention covers the modifications, combinations and variations of this invention provided they come within the scope of the appended claims and their equivalents.

What is claimed is:

1. A rotating utensil system comprising:
a) a manual rotation assembly comprising:
i) an actuator enclosure comprising a plunger gear aperture;
ii) a plunger comprising a plunger gear, said plunger extending through the plunger gear aperture to a plunger thumb end, said plunger gear comprising:
plunger gear teeth;
iii) a spring element in the actuator enclosure configured to force the plunger out through the plunger gear aperture to a ready position;
iv) shaft gear configured within the actuator enclosure and comprising:
shaft gear teeth that mate with the plunger gear teeth;
b) a handle coupled to the manual rotation assembly and extending from an actuator end coupled to the manual rotation assembly to a handle end;
c) a utensil shaft extending from a shaft-handle end to a shaft-utensil end, wherein the shaft is coupled with the shaft gear;
d) a utensil coupled to the shaft-utensil end;
wherein actuation of the plunger into the actuator enclosure through the plunger gear aperture moves the plunger gear and rotates the shaft gear at least 160 degrees and thereby rotates the utensil at least 160 degrees;
wherein the spring forces the plunger out of the actuator enclosure to a ready position and rotates the utensil shaft and utensil back to a ready position.

2. The rotating utensil system of claim 1, wherein the utensil shaft is detachably attachable to the manual rotation assembly.

3. The rotating utensil system of claim 1, wherein the utensil shaft is detachably attachable to the shaft gear.

4. The rotating utensil system of claim 3, wherein the utensil shaft is detachably attachable to the shaft gear by a utensil coupler.

5. The rotating utensil system of claim 4, wherein the utensil coupler comprises a protrusion and a protrusion aperture configured for the protrusion to extend therethrough.

6. The rotating utensil system of claim 1, wherein the actuator enclosure comprises:
a) a first enclosure component; and
b) a second enclosure component.

7. The rotating utensil system of claim 6, wherein the plunger gear aperture is configured in the second enclosure component.

8. The rotating utensil system of claim 7, wherein the actuator enclosure comprises a shaft gear aperture for the utensil shaft or a portion of the shaft gear to extend therethrough.

9. The rotating utensil system of claim 8, wherein the plunger gear aperture is in the second enclosure component.

10. The rotating utensil system of claim 9, wherein the shaft gear aperture is configured between the first enclosure component and the second enclosure component.

11. The rotating utensil system of claim 1, wherein the utensil is a spatula.

12. The rotating utensil system of claim 11, wherein the spatula is detachably attachable to the manual rotation assembly.

13. The rotating utensil system of claim 1, comprising a plurality of utensils including a spatula and wherein the plurality of utensils are detachably attachable to the manual rotation assembly.

14. The rotating utensil system of claim 13, wherein the plurality of utensils are detachably attachable to the manual rotation assembly by a utensil coupler comprising a protrusion coupled to a shaft gear extension, and a protrusion aperture in the handle.

15. The rotating utensil system of claim 14, wherein the utensil coupler further comprises a spring to force the protrusion through the protrusion aperture in the handle.

16. The rotating utensil system of claim 15, wherein the plurality of utensils further comprises a fork and a spoon.

17. The rotating utensil system of claim 1, wherein the plunger interface has a plunger interface extension extending back toward the handle.

18. A rotating utensil system comprising:
a) a manual rotation assembly comprising:
i) an actuator enclosure comprising:
a first enclosure component;
a second enclosure component;
a plunger gear aperture in the second enclosure component; and
a shaft gear aperture;
ii) a plunger comprising a plunger gear, said plunger extending through the plunger gear aperture to a plunger thumb end, said plunger gear comprising:
plunger gear teeth;
iii) a spring element in the actuator enclosure configured to force the plunger out through the plunger gear aperture to a ready position;
iv) shaft gear configured within the actuator enclosure and comprising:
shaft gear teeth that mate with the plunger gear teeth; and
a shaft gear extension having a protrusion and protrusion-spring;
b) a handle coupled to the and extending from an actuator end to a handle end;
c) a utensil shaft extending from a shaft-handle end to a shaft-utensil end, wherein the shaft is coupled with the shaft gear; said utensil shaft comprising a shaft aperture to receive the protrusion therethrough to detachably attach the utensil shaft to the manual rotation assembly;
d) a utensil coupled to the shaft-utensil end;
wherein the plunger gear aperture is configured for the plunger gear to extend therethrough and interface with the shaft gear within the actuator enclosure;
wherein the shaft gear aperture is configured for the utensil shaft or a portion of the shaft gear to extend therethrough;
wherein actuation of the plunger into the actuator enclosure through the plunger gear aperture moves the plunger gear and rotates the shaft gear at least 160 degrees and thereby rotates the utensil at least 160 degrees; and
wherein the spring forces the plunger out of the actuator enclosure to a ready position and rotates the utensil shaft and utensil back to a ready position.

19. The rotating utensil system of claim 18, comprising a plurality of utensils including a spatula and wherein the plurality of utensils are detachably attachable to the manual rotation assembly.

20. The rotating utensil system of claim 19, wherein the plurality of utensils are detachably attachable to the manual rotation assembly by a utensil coupler comprising a protrusion coupled to a shaft gear extension, and a protrusion aperture in the handle.
